(19) United States
(12) Patent Application Publication
(10) Pub. No.: US 2011/0148746 A1
(43) Pub. Date: Jun. 23, 2011

(54) SEALED FLEXIBLE LIGHT EMITTING DIODE DISPLAY SYSTEM WITH REMOTE WATERPROOF CONTROL

(76) Inventor: Philip Eric Devorris, Altoona, PA (US)

(21) Appl. No.: 12/642,359

(22) Filed: Dec. 18, 2009

(51) Int. Cl. G09G 3/32

(52) U.S. Cl. 345/82

(57) ABSTRACT

A sealed flexible light emitting diode (LED) display system with remote waterproof control includes: a flexible light emitting diode display; a circuit board that controls the display; a connector that provides signals to the circuit board; an encapsulating material that encloses the circuit board and exposes the connector; and a control device that provides signals to the connector to display the information.

### BACKGROUND OF THE INVENTION

The present invention generally relates to displays, and more specifically, to a sealed flexible light emitting diode (LED) display system with remote waterproof control.

Traditional LED display systems are heavy self contained units that require significant fabrication to be placed into a sign, especially as a retrofit. Current systems require a larger cabinet to contain the electronic boards and control system. They are too large and heavy to be mounted directly to the face, so are more difficult to retrofit in existing signs, especially if multiple gas prices are desired.

As can be seen, there is a need for a flexible LED display.

### SUMMARY OF THE INVENTION

In one aspect of the present invention, a system for displaying information includes: a flexible light emitting diode display; a circuit board that controls the display; a connector that provides signals to the circuit board; an encapsulating material that encloses the circuit board and exposes the connector; and a control device that provides signals to the connector to display the information.

In another aspect of the present invention, a system for displaying information includes: a flexible light emitting diode display; a circuit board that controls the display; a connector that provides signals to the circuit board; a waterproof encapsulating material that encloses the circuit board and exposes the connector; a control device that provides signals to the connector to display the information; a receiver to receive the information and provide the information to the control device; a power supply to provide power to the system; and a waterproof container to generally enclose the power supply, the control device, and the receiver.

In yet another aspect of the present invention, a method of displaying information on a curved sign face includes: providing a flexible light emitting diode display having a waterproof circuit board; applying the display to the curved sign face; controlling the circuit board with a waterproof control device; and remotely communicating with the circuit board to provide the information.

These and other features, aspects and advantages of the present invention will become better understood with reference to the following drawings, description and claims.

### BRIEF DESCRIPTION OF THE DRAWINGS

FIG. 1 depicts an embodiment of a text and graphics display system according to the present invention; and

FIG. 2 depicts an embodiment of a gas display system according to the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a fully sealed flexible LED display system with a remote waterproof control box.

An embodiment of the present invention includes LED display tiles that are fully potted, are ½″ thick for example, and may be mounted to the face of an existing sign. They are fully potted, in that they are embedded on both sides in an insulating or protective material, with apertures for connectors. They are flexible, so they follow the contour of curved sign faces. The power and control system is contained in a remote waterproof box that may fit in many signs. Communication and control elements are contained in a compact, remote-wired waterproof box that provides flexibility of mounting locations at or near the sign. Large digits and message center tiles are modular and can be mounted to any surface in any quantity for scalable displays.

An embodiment includes display tiles, a control device, a power supply, cable connections, a communication device, and an operator interface.

Embodiments of display tiles are made up of printed circuit boards onto which are soldered light emitting diodes (LEDs), current limiting resistors, and other circuit control devices. Connectors are also part of the circuit board; typically these are out the back, to penetrate the sign face and keep all cable connections inside the sign. Circuit boards are then covered by a flexible, waterproof potting material. Mounting holes are also provided for installation.

An embodiment of a system control device may include printed circuit boards with control and diagnostic components. These boards include a controller board, which supplies information to be displayed, and driver boards which control sections of the sign (a single price for example). The driver boards connect to each digit individually. The control board receives data from the communication device, and supplies driver boards with information on what each tile should display.

Power may be supplied to the system from embodiments of DC power supplies. The number of power supplies depends on the overall size of the display. This is in the form of direct current (DC) of an appropriate voltage, which is converted on a control board to other voltages as required by individual components. One embodiment utilizes 12V DC to power the components. The operator interface also has a power supply, in the form of a plug-in transformer, which varies depending on the system and type of interface.

In an embodiment, data and/or power are supplied to display tiles through cables. These take several forms, depending on the type of display. Gas price systems utilize custom made cables that send power to individual LED clusters. Graphic/text displays utilize special cables for power and CATS for data; there is also a daisy-chain interconnect between graphic tiles. Cables connect the control device to the communication device, as well as to an optional service terminal at the base of the sign. The operator interface is connected to power and to the communication device as appropriate to its type.

In an embodiment of a communication device, information to be displayed is transmitted from the operator interface to the control device via several different options. Devices supplied include hard-wired CATS or fiberoptic, WIFI, serial radio frequency (RF), and modem. These options allow flexibility for customer options as well as to match site conditions where some options are not feasible. The communication device ranges from a simple cable to a sophisticated secure WIFI device.

An embodiment of an operator interface may range from a simple handheld remote, to a remote terminal with display screen, and to a laptop computer providing content creation and scheduling.

In other embodiments, components are available for convenience, troubleshooting, and special features. These include remote access points, an energy relay to control other devices, and an information mode displayed on the sign face. The system can also be programmed to interface with Point of Sale (POS) systems to automatically display content generated for other purposes. Systems can be controlled remotely via the internet.

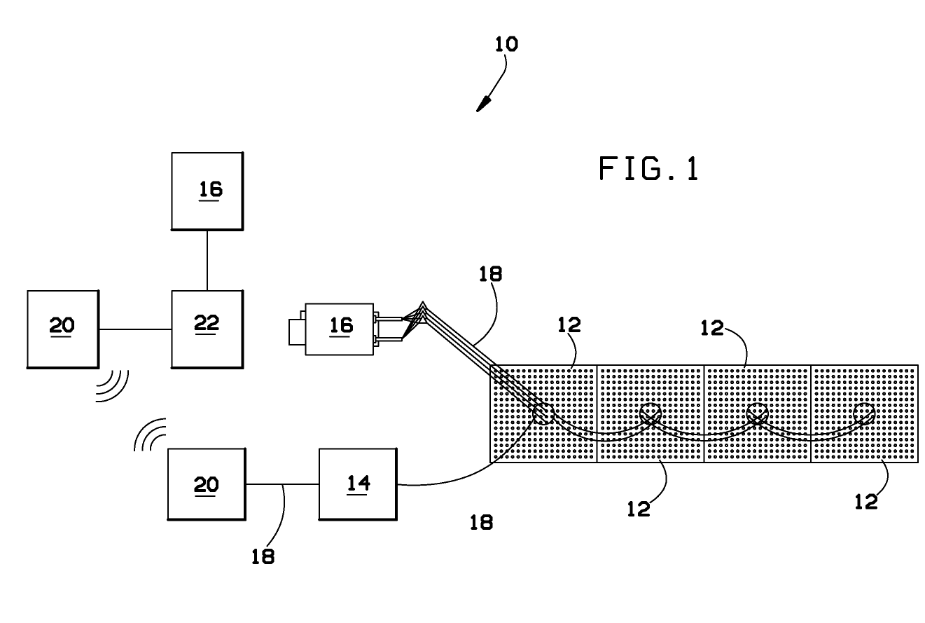

As depicted in FIG. 1, an embodiment of a text and graphics display system 10 includes display tiles 12, located on the sign face, of varying material types. Control devices 14 connect to display tiles 12 with data and power cables 18. The control devices 14 are located inside a waterproof enclosure. This enclosure is mounted in or near the sign. Power supplies 16 provide DC power for all components. Power supplies 16 are mounted to the control box, or nearby. Communication devices 20 connect to control device 14 at the sign, and a user interface 22 at an office or store. In an exemplary embodiment the communication is a hardwired connection, as this is most stable and least subject to interference.

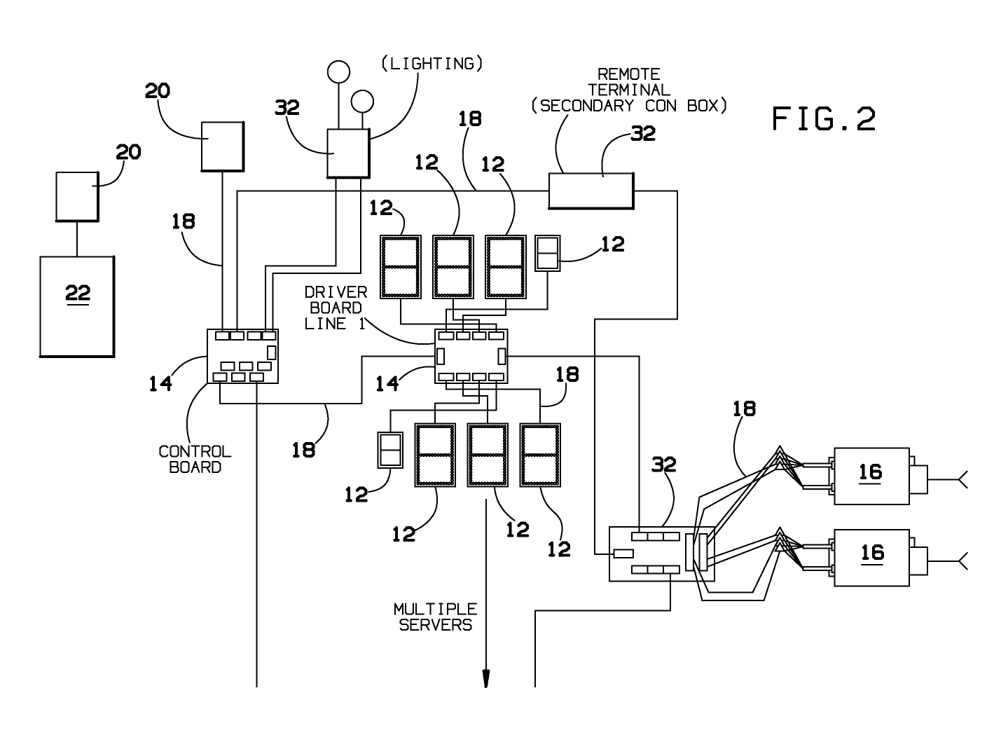

As depicted in FIG. 2, an embodiment of a gas price display system 30 includes other options such as WIFI, radio frequency, modem, or other ancillary devices 32.

A control device provides secondary functions such as turning on lights and diagnostics. Additional functions could be added based on customer requests or special developments.

It should be understood, of course, that the foregoing relates to exemplary embodiments of the invention and that modifications may be made without departing from the spirit and scope of the invention as set forth in the following claims.

We claim:

1. A system for displaying information, comprising:
a flexible light emitting diode display;
a circuit board that controls the display;
a connector that provides signals to the circuit board;
an encapsulating material that encloses the circuit board and exposes the connector; and
a control device that provides signals to the connector to display the information.

2. The system of claim 1, further comprising:
a communications interface that provides the information to the control device.

3. The system of claim 1, further comprising:
a receiver connected to the control device; and
a transmitter in remote communication with the receiver;
wherein the transmitter communicates the information to the receiver, and the receiver provides the information to the control device.

4. The system of claim 1, wherein the encapsulating material is waterproof and the control device is waterproof.

5. The system of claim 1, further comprising:
a power supply to provide power to the system; and
a waterproof container to generally enclose the power supply and the control device.

6. The system of claim 1, further comprising:
a user interface to provide the information from a user to the control device.

7. The system of claim 1, further comprising:
a plurality of flexible light emitting diode displays arranged side by side so as to provide a multi-character display.

8. A system for displaying information, comprising:
a flexible light emitting diode display;
a circuit board that controls the display;
a connector that provides signals to the circuit board;
a waterproof encapsulating material that encloses the circuit board and exposes the connector;
a control device that provides signals to the connector to display the information;
a receiver to receive the information and provide the information to the control device;
a power supply to provide power to the system; and
a waterproof container to generally enclose the power supply, the control device, and the receiver.

9. The system of claim 8, further comprising:
a plurality of flexible light emitting diode displays arranged side by side so as to provide a multi-character display; and
a transmitter to provide the information to the receiver; and
a user interface to provide the information to the transmitter.

10. A method of displaying information on a curved sign face, comprising:
providing a flexible light emitting diode display having a waterproof circuit board;
applying the display to the curved sign face;
controlling the circuit board with a waterproof control device; and
remotely communicating with the circuit board to provide the information.
